(19) United States
(12) Patent Application Publication
(10) Pub. No.: US 2025/0200168 A1
(43) Pub. Date: Jun. 19, 2025

(54) METHOD AND DEVICE FOR SENDING AND/OR RECEIVING MESSAGES IN A BUS COMMUNICATION SYSTEM

(71) Applicant: Robert Bosch GmbH, Stuttgart (DE)

(72) Inventors: Arthur Mutter, Neuhausen (DE); Friedrich Wiemer, Burgstetten (DE); Ramona Jung, Stuttgart (DE); Thomas Enderle, Muenchen (DE)

(21) Appl. No.: 18/970,517

(22) Filed: Dec. 5, 2024

(30) Foreign Application Priority Data
Dec. 18, 2023 (DE) 10 2023 212 865.9

(51) Int. Cl. G06F 21/44

(52) U.S. Cl. CPC G06F 21/44

(57) ABSTRACT

A method and a device for sending and/or receiving messages in a bus communication. The device includes a filter that is configured to restrict sending and/or receiving of messages in the bus communication to messages of authenticated participants of the bus communication, and to allow receiving a message for authenticating the device as participant of the bus communication, and a hardware security subsystem that is configured to authenticate the device as participant of the bus communication depending on the message for authenticating the device.

### CROSS REFERENCE

The present application claims the benefit under 35 U.S.C. § 119 of German Patent Application No. DE 10 2023 212 865.9 filed on Dec. 18, 2023, which is expressly incorporated herein by reference in its entirety.

### FIELD

The present invention concerns a method and a device for sending and/or receiving messages in a bus communication.

### BACKGROUND INFORMATION

The controller area network, CAN, is an example for a bus communication protocol. In the CAN communication any CAN node can access all communication on the bus, can write any message. CAN-XL is based on the concepts as specified in ISO 11898-1:2015. As a security protocol for CAN XL, CANsec can also partly be used to limit the access to the CAN communication to authorized nodes. For CANsec, dedicated Secure Zones are configured and a bus participant can only communicate as part of the Secure Zone, if it knows a shared secret key, i.e., if it is an authenticated member of the Secure Zone.

However, even if a full CANsec communication architecture is used, nodes can still send unprotected, e.g., non-CANsec messages, without restrictions.

### SUMMARY

According to an example embodiment of the present invention, a device for sending and/or receiving messages in a bus communication, comprises a filter that is configured to restrict sending and/or receiving of messages in the bus communication to messages of authenticated participants of the bus communication, and to allow receiving a message for authenticating the device as participant of the bus communication, and a hardware security subsystem that is configured to authenticate the device as participant of the bus communication depending on the message for authenticating the device. This prevents that an unauthorized participant is able to send unprotected messages without restrictions.

The filter may be configured to allow sending a message for requesting to authenticate the device as participant. This enables a node that is not yet participating in the bus communication to request a participation in the bus communication.

The filter may be configurable to restrict sending and/or receiving of messages in the bus communication to the messages of the authenticated participants, wherein the hardware security subsystem is configured to configure the filter to restrict sending and/or receiving of messages in the bus communication to the messages of the authenticated participants and/or to configure the filter to allow receiving the message for authenticating the device as participant of the bus communication. This enables a configuration of the security level of the communication within the device.

The hardware security subsystem may be configured to restrict the sending and/or receiving of messages in the bus communication to the messages of the authenticated participants upon authenticating the device as participant of the bus communication. This restricts the authentication to participating in one bus communication.

The filter and the hardware security subsystem may be configured to restrict the sending and/or receiving of messages in the bus communication to one or more communication zones of the bus communication. This restricts the authentication to participating in the zone or the zones.

According to an example embodiment of the present invention, a method in a device for sending and/or receiving messages in a bus communication, comprises filtering messages with a filter that is configured to restrict sending and/or receiving of messages in the bus communication to messages of authenticated participants of the bus communication, and to allow receiving a message for authenticating the device as participant of the bus communication, and authenticating the device with a hardware security subsystem that is configured to authenticate the device as participant of the bus communication depending on the message for authenticating the device.

According to an example embodiment of the present invention, in the method, the filter may be configured to allow sending a message for requesting to authenticate the device as participant.

According to an example embodiment of the present invention, in the method, the filter may be configurable to restrict sending and/or receiving of messages in the bus communication to the messages of the authenticated participants, wherein the hardware security subsystem is configured to configure the filter to restrict sending and/or receiving of messages in the bus communication to the messages of the authenticated participants and/or to configure the filter to allow receiving the message for authenticating the device as participant of the bus communication, wherein the method comprises configuring the filter with the hardware security subsystem.

According to an example embodiment of the present invention, in the method, the hardware security subsystem may be configured to restrict the sending and/or receiving of messages in the bus communication to the messages of the authenticated participants upon authenticating the device as participant of the bus communication, wherein the method comprises configuring the filter with the hardware security subsystem upon authenticating the device as participant of the bus communication.

According to an example embodiment of the present invention, in the method, the filter and the hardware security subsystem may be configured to restrict the sending and/or receiving of messages in the bus communication to one or more communication zones of the bus communication, wherein the method comprises restricting the sending and/or receiving of messages in the bus communication to the one or more communication zones.

A computer program may comprise computer readable instructions that, when executed by a computer, cause the computer to execute the method according to the present invention.

Further advantageous embodiments of the present invention are derivable from the following description and the figures.

### BRIEF DESCRIPTION OF THE DRAWINGS

FIG. 1 schematically depicts a bus communication system, according to an example embodiment of the present invention.

FIG. 2 schematically depicts a device for participating in a bus communication, according to an example embodiment of the present invention.

FIG. 3 schematically depicts a method for authenticating the device, according to an example embodiment of the present invention.

FIG. 4 schematically depicts a frame of a message in the bus communication, according to an example embodiment of the present invention.

FIG. 5 schematically depicts the bus communication system with the device outside of a zone for the bus communication, according to an example embodiment of the present invention.

FIG. 6 schematically depicts the bus communication system with the devices inside the zone for the bus communication, according to an example embodiment of the present invention.

### DETAILED DESCRIPTION OF EXAMPLE EMBODIMENTS

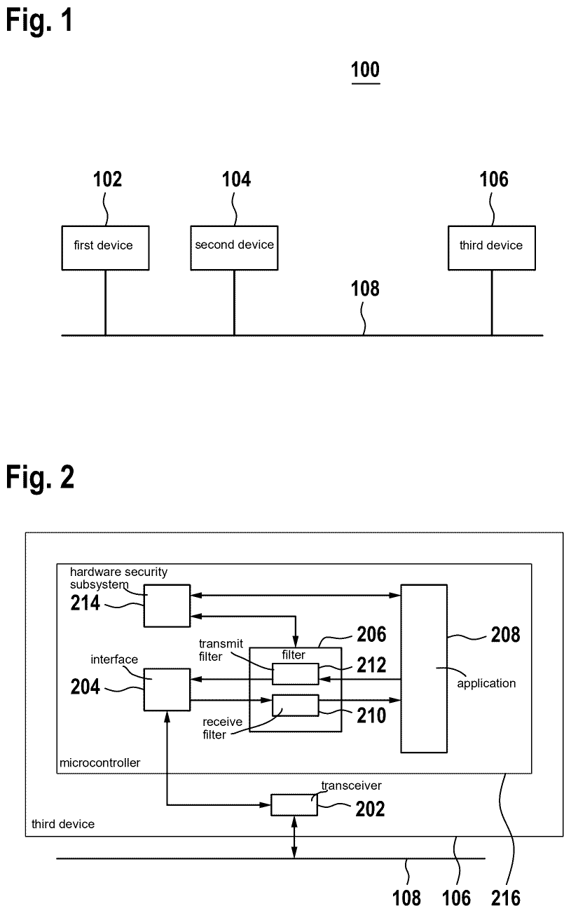

FIG. 1 schematically depicts a bus communication system 100. The bus communication system 100 comprises a first device 102, a second device 104 and a third device 106. The first device 102 may be the bus master for the bus communication system 100. The bus communication system comprises a communication bus 108. The first device 102, the second device 104 and the third device 106 are configured to exchange messages on the communication bus 108.

The first device 102 is configured to participate in the bus communication. The first device 102 is configured to authenticate other devices for participating in the bus communication.

The second device 104 is configured to participate in the bus communication. The second device 104 in the example is authenticated by the first device 102.

FIG. 2 schematically depicts the third device 106.

The third device 106 comprises transceiver 202, that implements a physical access layer, PHY, to the communication bus 108.

The third device 106 comprises an interface 204. The interface 204 is configured for sending messages to the transceiver 202 and/or for receiving messages from the transceiver 202.

The third device 106 comprises a filter 206.

The filter 206 is configurable to restrict sending and/or receiving of messages in the bus communication to messages of authenticated participants of the bus communication. The filter 206 may be configured to restrict sending and/or receiving of messages in the bus communication to messages of authenticated participants of the bus communication.

The filter 206 is configured to allow receiving a message for authenticating the device 106 as participant of the bus communication. The filter 206 may be configurable to reject or allow receiving the message for authenticating the device 106 as participant of the bus communication.

The third device 106 comprises an application 208. The application 208 is configured to determine messages to be sent in the bus communication and/or to process messages that are received in the bus communication.

The application 208 is for example configured to determine a message for requesting the authentication of the device 106 for participation in the bus communication.

The application 208 is for example configured to process a message authenticating the device 106 for participation in the bus communication.

The application 208 is optionally configured to determine a message for requesting an authorization token for configuring the filter 206.

The application 208 is configured to process a message comprising the authorization token for configuring the filter 206.

Restricting the sending and/or receiving in this context may mean that the filter 106 only allows messages to pass the filter 106, that are received from or sent to an authenticated device or an authenticated zone of the bus communication system. The zone may be a virtual private part of the bus communication system. The filter 206 may be configurable for the participation in different zones. The messages may comprise an indication of the zone they are intended for.

The filter 206 may comprise a receive filter 210 for filtering messages that are received, and a transmit filter 212 for filtering messages to be sent. The parts may be configurable to allow or restrict the sending and/or receiving of messages depending on the indication of the zone.

The third device 106 comprises a hardware security subsystem 214 that is configured to authenticate the device 106 as participant of the bus communication. The hardware security subsystem 214 is configured to authenticate the device 106 as participant depending on the message for authenticating the device 106. The message for authenticating the device 106 is for example provided to the hardware security subsystem 214 by the application 208.

The hardware security subsystem 214 is configured to configure the filter 206. The hardware security subsystem 214 is for example configured to configure the filter 206 to restrict the sending and/or receiving of messages to devices authenticated for participation in the bus communication.

According to an example, the interface 204, the filter 206, the application 208 and the hardware security subsystem 214 are integrated in a microcontroller 216. The application 208 may be executed on a central processing unit of the microcontroller 216. The filter 206 may be a hardware filter.

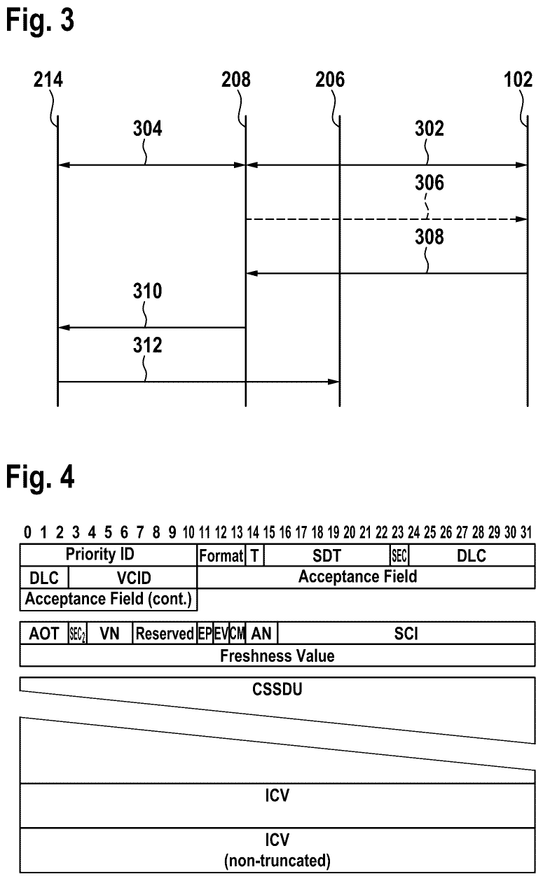

FIG. 3 schematically depicts an exemplary method for authenticating the third device 106. The method comprises two phases, authentication and manage access control.

### Authentication

The first phase comprises an authentication protocol, where a new participant, e.g., the third device 106 authenticates itself towards a bus master, e.g., the first device 102. According to an exemplary implementation of the first phase, a cryptographic authentication (key agreement) protocol is used. The authentication may be based on asymmetric cryptography, e.g., where both the first device 102 and the third device 106 own private & public key pairs. The authentication may be based on shared symmetric cryptographic secrets.

The exemplary method comprises a communication 302 between the application 208 and the first device 102 for authenticating the third device 106. The exemplary method comprises a communication 304 between the application 208 and the hardware security subsystem 214 for authenticating the third device 106.

The first phase, on successfully authenticating the new participant may result in a shared secret. This shared secret may be used as a symmetric cryptographic key, referred to as a session key, to establish a secure communication channel for the second phase, i.e. the mange access control phase. Optionally a mutual authentication is used wherein both the first device 102 and the third device 106 are mutually authenticated.

### Manage Access Control

The second phase can either be initiated by the third device 106, or by the first device 102.

To initiate the second phase by the third device 106, the exemplary method optionally for example comprises sending a request 306 from the application 208 to request the authorization token from the first device 102. For example, the third device 106 generates a request-token. The request-token may specify communication rights the third device 106 wants to gain. The third device 106 may send the request token in the request 306, e.g., through the secure channel to the first device 102.

The first device 102, as the bus master, checks the access rights for the third device 106, for example by taking the received request-token into account, and generates a new authorization token, which specifies the actual access rights that will be granted to the third device 106.

Alternatively, the third device 106 does not request new access rights with a request-token, but the first device 102 checks, e.g., an internal data base of access rights for the third device 106 and informs the third device 106 of the corresponding rights from this data base via the authorization token. In this case, the first device 102 initiates the second phase after successfully authenticating the third device 106.

The exemplary method comprises receiving, by the application 208, a message 308 from the first device 102 comprising the authorization token.

The first device 102 may cryptographically protect the authenticity of this authorization-token, e.g., either by an asymmetric signature or by a symmetric Message Authentication Code, MAC.

The first device 102 may send the authorization-token, e.g., through the secure channel, to the third device 106.

According to the exemplary method, the filter 206 is configured to allow receiving the message 308 comprising the authorization token. The filter 206 is optionally configured to allow sending the request 306.

According to the exemplary method, the filter 206 is configured to restrict sending and/or receiving of messages in the bus communication to messages of authenticated participants of the bus communication. This means, except for the message 308 and optionally the request 306, the third device 106 is unable to send any messages in the bus communication to the first device 102 or any other device in the bus communication until the third device 106 is authenticated as participant in the bus communication by the first device 102.

The third device 106, on reception of this signed authorization token, may process this token in the hardware security subsystem 214. For example, the third device 106 verifies the validity of the authorization token and, if the check of the validity is successful, reconfigures the filter 206 to match the new communication access rights.

The exemplary method comprises sending the authorization token in a step 310 from the application 206 to the hardware security subsystem 214.

The method comprises configuring the filter 206 with the hardware security subsystem 214 in a step 312.

This means, the filter 206 is configured with the hardware security subsystem 214 to restrict the sending and/or receiving of messages to the participants in the bus communication upon authenticating the device 106 as participant of the bus communication.

The communication between the first device 102 and the third device 106 in the second phase is not necessarily protected by the secure channel. For example, the authorization token is protected by a cryptographic checksum, e.g., a signature or MAC. Therefore, an adversary cannot manipulate the authorization token and the third device 106 can verify the validity of the authorization token and use the authorization token only if the validity of the authorization token is verified. The authorization token may be tied by the first device 102 to the third device 106. For example, the authorization token is tied to an identity of the third device 106.

The filter 206 and the hardware security subsystem 214 may be configured to restrict the sending and/or receiving of messages in the bus communication to one or more communication zones of the bus communication.

The method may comprise restricting the sending and/or receiving of messages in the bus communication to the one or more communication zones.

According to an example, the communication system 100 is a CAN XL or a CANSec system.

The first device 102, the second device 104 and the third device 106 are for example CAN XL communication control devices that implement the CAN protocol, and additionally the filter 206. The filter 206 in the example allows to filter in hardware the first e.g. 4 byte of a CAN frame. The filter result is for example either “store frame” or “drop frame”.

The CAN XL communication control devices additionally implement the receive filter 210 that limits the frames that can be received according to CAN XL protocol.

The CAN XL communication control devices additionally implement the transmit filter 212 that limits the frames that can be sent according to CAN XL protocol.

The receive filter 210 and the transmit filter 212 is secured in the sense that only the hardware security subsystem 214, in the microcontroller 216 can change the filter configuration of the filter 206.

This means, the CAN XL communication control devices can be configured to be allowed to send only specific messages and also to receive only a specific set of messages.

As a security protocol for CAN XL, CANsec may be used. For CANsec, dedicated zones, i.e. Connectivity Associations, are configured and the CAN XL communication control devices have to know a shared secret key of the Connectivity Association in order to communicate as part of the Connectivity Association.

The CANsec communication protocol may be used in addition to the CAN XL protocol and the filter 206 in order to protect the messages with CANsec. CANsec may be used in the CAN XL communication control devices, e.g., to ignore messages of an attacker.

FIG. 4 schematically depicts a CANsec frame of a CANsec message in the bus communication.

The CANsec frame in the example comprises a field Priority ID that provides a priority of the frame. The CANsec frame in the example comprises a field SDT that provides a type of the frame. The CAN XL frame may comprise a field VCID that provides an identifier for a virtual separation of the CAN bus. The CANsec frame in the example comprises a field Acceptance Field that provides information about the application.

The filter 206 is for example configured to examine the CANsec frame and to either drop the CANsec frame or allow the CANsec frame to pass the filter 206 depending on at least one of the fields Priority ID, SDT, VCID, Acceptance Field.

For example, the third device 106 is configured in such a way, that the third device 106 can only send and receive messages necessary for the bus authentication. Depending on the particular bus technology, this can for example be implemented by restricting this communication to a dedicated virtual network, that is identified by an ID of the virtual network. For example, the third device 106 is configured to send and/or receive messages only in a dedicated Virtual CAN network that is identified by the VCID.

FIG. 4 schematically depicts the bus communication system 100 with the third device 106 outside of a zone 502 for the bus communication. The first device 102 and the second device 104 are in the zone 502.

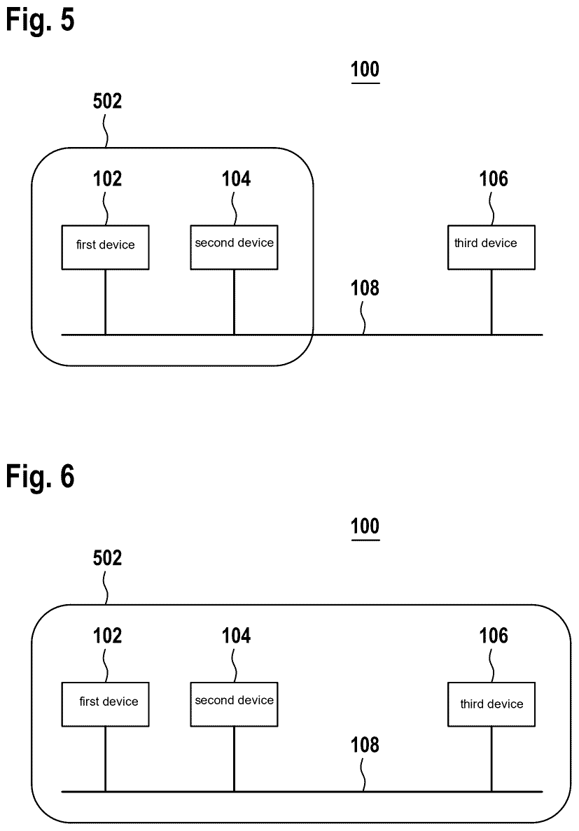

FIG. 5 schematically depicts the bus communication system with the devices inside the zone 502 for the bus communication.

According to an exemplary embodiment using CANsec, the zone 502 is a Connectivity Association CA A.

The first device 102, i.e., the bus master, and the second device 104 are part of CA A. The third device 106 is not yet part of CA A.

Other bus participants are not depicted, but might be listening on the communication bus 108.

Initially, CA A contains the first device 102 and the second device 104. The VCIDs are exemplary configured such that a VCID 1 is used for bus authentication communication. Every node is initially allowed to receive and send messages in the virtual CAN network VCID 1.

Initially, the VCIDs are exemplary configured such that VCID 65 is matched to CA A. The filter 206 in the third device 106 only allows to send/receive frames with VCID 65, if the third device 206 is part of CA A. The first device 102 and the second device 104 and, if applicable, any other device connected to the communication bus 108 may comprise a filter that only allows to send/receive frames with VCID 65, if the node is part of CA A.

In case further virtual CAN networks are used, the corresponding filters can be configured as needed, e.g., based on different VCIDs.

After a successful authentication at the bus master, i.e., the first device 102, the third device 106 requests or gains access granted to add VCID 65 to the filter 206 by a corresponding authorization token. The hardware security subsystem 214 of the third device 106 reconfigures the filter 206 based on the corresponding authorization token, and the application 208 is then able to send/receive frames with VCID 65.

Eventually, the third device 106 can communicate with participants in CA A.

and following the CANsec specification can agree with the other peers of the Connectivity Association CA A on new key material.

Applying bus authentication to CAN XL and CANsec with VCIDs is not restricted to virtual CAN networks. Depending on the actual features of the filter 206, other CAN XL header fields, e.g., the Priority ID, SDT, Acceptance Field may be used to restrict to the initially only allowed bus authentication communication, and maybe additional, unprotected communication.

According to an exemplary embodiment using CAN XL and CANsec with additional CANsec control plane, controlling the access of the third device 106 to a particular Connectivity Association comprises providing the third device 106 with the ability to take part of a session key agreement for the Connectivity Association.

For example, the participation in the session key agreement for the Connectivity Association is shown by being in possession of a corresponding long-term secret key, i.e., Connectivity Association Key, CAK. The actual communication within the Connectivity Association is protected by short-term secret session keys, i.e., Secure Association Keys, SAKs.

These SAKs are derived and distributed within the Connectivity Association in regular intervals in a secure way with the help of the corresponding CAK. According to the example, the CANsec control plane protocol is used for distributing the SAKs.

The filter 206 is for example configured to filter CAN XL LLC frames depending on the identifier for the CANsec control plane. The filter 206 is for example configured to filter CAN XL LLC frames depending on predetermined SDT value in the CAN XL LLC frame.

The filter 206 is for example configured to filter CAN XL LLC frames depending on a predetermined SEC bit and AOT field in the CAN XL LLC frame.

For example, filtering comprises setting the SEC bit with a following corresponding value in the AOT field.

For both variants, the filter 206 may be configured to block the control plane messages, until a successful authentication of the third device 106 was done.

Once the third device 106 is successfully authenticated towards the bus master, i.e., the first device 102, the filter 206 may be reconfigured as described above.

Only after this reconfiguration, the third device 106 is able to send and receive CANsec control plane messages and thus take part in the needed key distribution phase for setting up the CANsec communication.

A combination of an SDT value (Control Plane frames) and a VCID is also possible. This means, that the third device 106 is only allowed to send CANsec Control Plane messages inside its own VCID. So, if the application 208 of the third device 106 was compromised the application 208 can neither receive from nor send control plane messages to other secure zones.

When using CAN XL and CANsec, this bus authentication adds another security layer to further protect and restrict communication.

The disclosure is not limited to the communication bus 108. The method is applied across several connected communication busses as described for the communication bus 108.

What is claimed is:

1. A device for sending and/or receiving messages in a bus communication, the device comprising:
a filter configured to: (i) restrict sending and/or receiving of messages in the bus communication to messages of authenticated participants of the bus communication, and (ii) allow receiving a message for authenticating the device as a participant of the bus communication; and
a hardware security subsystem configured to authenticate the device as a participant of the bus communication depending on the message for authenticating the device.

2. The device according to claim 1, wherein the filter is configured to allow sending a message for requesting to authenticate the device as a participant.

3. The device according to claim 1, wherein the filter is configurable to restrict sending and/or receiving of messages in the bus communication to the messages of the authenticated participants, and wherein the hardware security subsystem is configured to configure the filter to restrict the sending and/or receiving of messages in the bus communication to the messages of the authenticated participants and/or to configure the filter to allow receiving the message for authenticating the device as a participant of the bus communication.

4. The device according to claim 3, wherein the hardware security subsystem is configured to restrict the sending and/or receiving of messages in the bus communication to the messages of the authenticated participants upon authenticating the device as a participant of the bus communication.

5. The device according to claim 3, wherein the filter and the hardware security subsystem are configured to restrict the sending and/or receiving of messages in the bus communication to one or more communication zones of the bus communication.

6. A method in a device for sending and/or receiving messages in a bus communication, the method comprising:
filtering messages with a filter that is configured to: (i) restrict sending and/or receiving of messages in the bus communication to messages of authenticated participants of the bus communication, and (ii) allow receiving a message for authenticating the device as participant of the bus communication; and
authenticating the device with a hardware security subsystem that is configured to authenticate the device as a participant of the bus communication depending on the message for authenticating the device.

7. The method according to claim 6, wherein the filter is configured to allow sending a message for requesting to authenticate the device as a participant.

8. The method according to claim 6, wherein the filter is configurable to restrict sending and/or receiving of messages in the bus communication to the messages of the authenticated participants, wherein the hardware security subsystem is configured to configure the filter to restrict sending and/or receiving of messages in the bus communication to the messages of the authenticated participants and/or to configure the filter to allow receiving the message for authenticating the device as a participant of the bus communication, and wherein the method further comprises configuring the filter using the hardware security subsystem.

9. The method according to claim 8, wherein the hardware security subsystem is configured to configure the filter to restrict the sending and/or receiving of messages in the bus communication to the messages of the authenticated participants upon authenticating the device as a participant of the bus communication, and wherein the method further comprises configuring the filter with the hardware security subsystem upon authenticating the device as a participant of the bus communication.

10. The method according to claim 6, wherein the filter and the hardware security subsystem are configured to restrict the sending and/or receiving of messages in the bus communication to one or more communication zones of the bus communication, and wherein the method further comprises restricting the sending and/or receiving of messages in the bus communication to the one or more communication zones.

11. A non-transitory computer-readable medium on which is stored a computer program including computer readable instructions that, when executed by a computer, cause the computer to execute a method in a device for sending and/or receiving messages in a bus communication, the method comprising the following steps:
filtering messages with a filter that is configured to: (i) restrict sending and/or receiving of messages in the bus communication to messages of authenticated participants of the bus communication, and (ii) allow receiving a message for authenticating the device as participant of the bus communication; and
authenticating the device with a hardware security subsystem that is configured to authenticate the device as a participant of the bus communication depending on the message for authenticating the device.
